(19) United States
(12) Patent Application Publication
(10) Pub. No.: US 2014/0200080 A1
(43) Pub. Date: Jul. 17, 2014

(54) 3D DEVICE AND 3D GAME DEVICE USING A VIRTUAL TOUCH

(71) Applicant: VTouch Co., Ltd., Seoul (KR)

(72) Inventor: Seok-Joong Kim, Seoul (KR)

(73) Assignee: VTouch Co., Ltd., Seoul (KR)

(21) Appl. No.: 14/126,476

(22) PCT Filed: Jun. 12, 2012
(86) PCT No.: PCT/KR2012/004632

§ 371 Date: Feb. 27, 2014

(30) Foreign Application Priority Data
Jun. 15, 2011 (KR) 10-2011-0057719

(51) Int. Cl. A63F 13/00

(52) U.S. Cl. CPC A63F 13/00
USPC 463/32

(57) ABSTRACT

Provided is a 3D game device using a virtual touch, the three-dimensional game device using a virtual touch includes a 3D game executing unit rendering a 3D stereoscopic game pre-stored in a game database and generating a 3D stereoscopic image regarding the rendered 3D game to provide the 3D stereoscopic image to a display unit, and a virtual touch unit generating spatial coordinate data of a specific point of a user and image coordinate data from a user's viewpoint using the 3D stereoscopic image provided from the display unit and comparing the generated spatial coordinate data and image coordinate data to verify whether or not a specific point of a user contacts or approaches the 3D stereoscopic image and thus recognize a touch of the 3D stereoscopic image.

### TECHNICAL FIELD

The following disclosure relates to a 3D game device and method, and more particularly, to a 3D device and 3D game device using a virtual touch, which more precisely controls a virtual 3D stereoscopic image for playing game as image coordinates of the 3D stereoscopic image contacts or approaches a specific position of a user.

### BACKGROUND ART

Human has two eyes (left eye and right eye), locations of which are different from each other. Accordingly, an image focused on the retina of the right eye and an image focused on the retina of the left eye are different from each other. Objects coming into view differ in their locations of images focused on the left and right eyes according to distances from a viewer. That is, as the location of an object becomes closer, images focused on two eyes significantly differ. On the other hand, as the location of an object become farther, a difference between the images focused on two eyes disappears. Accordingly, information on the distance from the object can be obtained from the difference between the image focused on the left and right eyes, allowing a viewer to feel the three-dimensional effect.

Thus, a stereoscopic image can be implemented by allowing two eyes to view different images using the foregoing principle. This method is being used for 3D images, 3D games, and 3D movies. 3D games are also implemented by allowing two eyes to view different images to form a 3D stereoscopic image.

However, since a general display unit, not a display unit for a 3D stereoscopic image, allows a user to feel the three-dimensional effect only at a fixed viewpoint, the image quality may be reduced by the motion of a user.

In order to overcome the foregoing limitation, stereoscopic glasses are being disclosed to allow a user to view stereoscopic images displayed on a display unit regardless of a position of a user. Recently, a 3D display unit (monitor) is being developed for 3D images and 3D games, and active studies are being conducted for the 3D stereoscopic images.

However, the foregoing 3D stereo image implementation technology using optical illusion of 3D stereoscopic images caused by a difference of point of view between the left eye and the right eye does not directly actual 3D stereo images like a hologram. Accordingly, 3D stereoscopic images are provided to comply with the point of user's view by providing different views to the left eye and the right eyes from the point of view of a user.

Thus, the depth (perspective) of 3D stereoscopic images has different values according to a distance between a screen and a user. Even in case of the same image, a user feels a small depth when viewing the image from a short distance to the screen, but feels a large depth when viewing the image from a long distance. This means that the depth of an image also varies according to the change of the distance between a user and a screen. Also, according to the position of a user in addition to the distance between a user and a screen, the depth (perspective) of the 3D stereoscopic image and the position of an image have different values. This means that the position of the 3D image varies according to whether a user views the image from the front of a virtual 3D stereoscopic screen or from the side of the screen.

This reason is because the 3D stereoscopic image does not exist at a certain location but is formed according to the point of user's view.

Thus, due to the depth and position of the 3D stereoscopic image varying according to the point of user's view, accurate calculation is difficult, simply providing only the 3D stereoscopic image in case of a 3D game. Also, the manipulation is usually performed through an external input device. Also in case of 3D games using a virtual touch technology, which is recently being developed, for this reason, only the motion of a user is simply applied to the games to play game. Accordingly, in case of 3D games using the virtual touch technology, the 3D stereoscopic image and the motion of a user are not combined with each other, but are independently applied.

Thus, even though a user playing a 3D game touches the 3D stereoscopic image that the user is viewing, the touch is not valid according to the distance and position from the screen, or an unintended operation may actuate, making it impossible to more realistically and accurately play 3D game.

### DISCLOSURE

### Technical Problem

Accordingly, the present disclosure provides a 3D game device using a virtual touch, which calculates a 3D stereoscopic image viewed by a user and 3D spatial coordinate data of a specific points of the user in a 3D game using a virtual touch technology, and allows the user to more precisely manipulate a virtual 3D stereoscopic image for playing game when the 3D stereoscopic image contacts or approaches the specific point of the user.

The present disclosure also provides a 3D game device using a virtual touch, which calculates a spatial coordinate of a specific point of a user and an image coordinate of a 3D stereoscopic image and recognizes a touch of a 3D stereoscopic image when the specific point of the user approaches the calculated image coordinate.

The present disclosure also provides a 3D device using a virtual touch, which calculates a 3D stereoscopic image viewed by a user and 3D spatial coordinate data of a specific point of the user using a virtual touch technology, and recognizes a touch of a virtual 3D stereoscopic image when the 3D stereoscopic image contacts or approaches the specific point of the user.

### Technical Solution

In one general aspect, a three-dimensional game device using a virtual touch, including: a 3D game executing unit rendering a 3D stereoscopic game pre-stored in a game database and generating a 3D stereoscopic image regarding the rendered 3D game to provide the 3D stereoscopic image to a display unit; and a virtual touch unit generating spatial coordinate data of a specific point of a user and image coordinate data from a user's viewpoint using the 3D stereoscopic image provided from the display unit and comparing the generated spatial coordinate data and image coordinate data to verify whether or not a specific point of a user contacts or approaches the 3D stereoscopic image and thus recognize a touch of the 3D stereoscopic image.

The specific point may include a tip of hand, a fist, a palm, a face, a mouth, a head, a foot, a hip, a shoulder, and a knee.

The 3D game executing unit may include: a rendering driving unit rendering and executing the 3D game stored in the game database; a real-time binocular rendering unit generating images corresponding to both eyes by performing rendering in real-time in consideration of a distance and a location (view angle) between the display unit and a user to generate a 3D screen on the display unit regarding the 3D game that is rendered; a stereoscopic image decoding unit compressing and restoring the images generated in the real-time binocular rendering unit; and a stereoscopic image expressing unit converting the image data compressed and restored in the stereoscopic image decoding unit into a 3D stereoscopic image suitable for the display method of the display unit to display the 3D stereoscopic image through the display unit.

The virtual touch unit may include: an image acquisition unit including two or more image sensors and detecting an image in front of the display unit to convert the image into an electric image signal; a spatial coordinate calculation unit generating image coordinate data according to the 3D stereoscopic image of a user's viewpoint from the image acquired by the image acquisition unit and first and second spatial coordinate data of a specific point of a user; a touch location calculation unit for calculating contact point coordinate data where a straight line connecting the first and second spatial coordinates of a specific point of a user received from the spatial coordinate calculation unit meets the image coordinate; and a virtual touch calculation unit determining whether or not the first spatial coordinate generated in the spatial coordinate calculation unit contacts or approaches the contact point coordinate data calculated in the touch location calculation unit to generate a command code for performing touch recognition of the 3D stereoscopic image when the first spatial coordinate contacts or approaches the contact point coordinate data within a predetermined distance.

The spatial coordinate calculation unit may calculate the spatial coordinate data of a specific point of a user from photographed images using optical triangulation.

The calculated spatial coordinate data may include the first spatial coordinate data for detecting a motion of a user for touching the 3D stereoscopic image and the second spatial coordinate data that is a reference point between the 3D stereoscopic image and the first spatial coordinate according to the motion.

The spatial coordinate calculation unit may retrieve and detect the image coordinate data of a user's viewpoint pre-defined and stored according to a distance and a location between the display unit and a user.

The second spatial coordinate may be a coordinate of a central point of one of user's eyes.

The virtual touch unit may include: a lighting assembly including a light source and a diffuser and projecting a speckle pattern on a specific point of a user; an image acquisition unit including an image sensor and a lens and capturing the speckle pattern of a user projected on the lighting assembly; a spatial coordinate calculation unit generating image coordinate data according to the 3D stereoscopic image of a user's viewpoint from the image acquired by the image acquisition unit and first and second spatial coordinate data of a specific point of a user; a touch location calculation unit for calculating contact point coordinate data where a straight line connecting the first and second spatial coordinates of a specific point of a user received from the spatial coordinate calculation unit meets the image coordinate; and a virtual touch calculation unit determining whether or not the first spatial coordinate generated in the spatial coordinate calculation unit contacts or approaches the contact point coordinate data calculated in the touch location calculation unit to generate a command code for performing touch recognition of the 3D stereoscopic image when the first spatial coordinate contacts or approaches the contact point coordinate data within a predetermined distance.

The spatial coordinate calculation unit may calculate the spatial coordinate data of a specific point of a user by time of flight.

The calculated spatial coordinate data may include the first spatial coordinate data for detecting a motion of a user for touching the 3D stereoscopic image and the second spatial coordinate data that is a reference point between the 3D stereoscopic image and the first spatial coordinate according to the motion.

The spatial coordinate calculation unit may retrieve and detect the image coordinate data of a user's viewpoint pre-defined and stored according to a distance and a location between the display unit and a user.

The image acquisition unit may include an image sensor including Charge-Coupled Device (CCD) or Complementary Metal-Oxide-Semiconductor (CMOS).

The virtual touch unit may be installed in an upper end of a frame of electronic equipment including the display unit, or may be installed separately from electronic equipment

In another general aspect, a three-dimensional device using a virtual touch, including: a 3D executing unit rendering 3D stereoscopic image data inputted from the outside and generating a 3D stereoscopic image regarding the rendered 3D stereoscopic image data to provide the 3D stereoscopic image to a display unit; and a virtual touch unit generating 3D spatial coordinate data of specific points of a user and 3D image coordinate data from a point of user's view regarding the 3D stereoscopic image provided from the display unit and comparing the generated spatial coordinate data and image coordinate data to verify whether or not the specific points of a user contact or approach the 3D stereoscopic image and thus recognize a touch of the 3D stereoscopic image.

The 3D executing unit may include: a reception unit receiving the 3D stereoscopic image data inputted from the outside; a rendering driving unit rendering and executing the 3D stereoscopic image data received by the reception unit; a real-time binocular rendering unit generating images corresponding to both eyes by performing rendering in real-time in consideration of a distance and a location (view angle) between the display unit and a user to generate a 3D screen on the display unit regarding the 3D stereoscopic image data that are rendered; a stereoscopic image decoding unit compressing and restoring the images generated in the real-time binocular rendering unit; and a stereoscopic image expressing unit converting the image data compressed and restored in the stereoscopic image decoding unit into a 3D stereoscopic image suitable for the display method of the display unit to display the 3D stereoscopic image through the display unit.

The external input of the reception unit may include an input of 3D broadcast provided through a broadcast wave, an input of 3D data provided through an Internet network, and an input of data stored in internal/external storages.

Other features and aspects will be apparent from the following detailed description, the drawings, and the claims.

### Advantageous Effects

As described above, a 3D game device using a virtual touch according to an embodiment of the present invention can allow a user to more precisely manipulate a virtual 3D stereoscopic image through a 3D stereoscopic image viewed by the user and spatial coordinate values of a specific point of the user, providing a more realistic and vivid 3D game. Also, through precise matching of the motion of a user and the 3D stereoscopic image viewed by the user, the 3D game device can be applied to various kinds of 3D games that need a small motion of the user.

Furthermore, in addition to the 3D games, the 3D game device can be applied to various application technologies by providing a virtual touch through the 3D stereoscopic image provided from the display unit and the spatial coordinates of a specific point of a user and thus performing a change of the 3D stereoscopic image in response to the virtual touch.

### DESCRIPTION OF DRAWINGS

FIG. 1 is a view illustrating a 3D game device using a virtual touch according to a first embodiment of the present invention.

FIGS. 2 and 3 are views illustrating a method of recognizing a touch of a 3D stereoscopic image viewed by a user in a 3D game using a virtual touch according to an embodiment of the present invention.

FIG. 4 is a view illustrating a 3D game device using a virtual touch according to a second embodiment of the present invention.

FIGS. 5 and 6 are views illustrating a method of recognizing a touch of a 3D stereoscopic image viewed by a user in a 3D game using a virtual touch according to an embodiment of the present invention.

FIG. 7 is a view illustrating a 3D device using a virtual touch according to a third embodiment of the present invention.

### MODE FOR INVENTION

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

### Embodiment 1

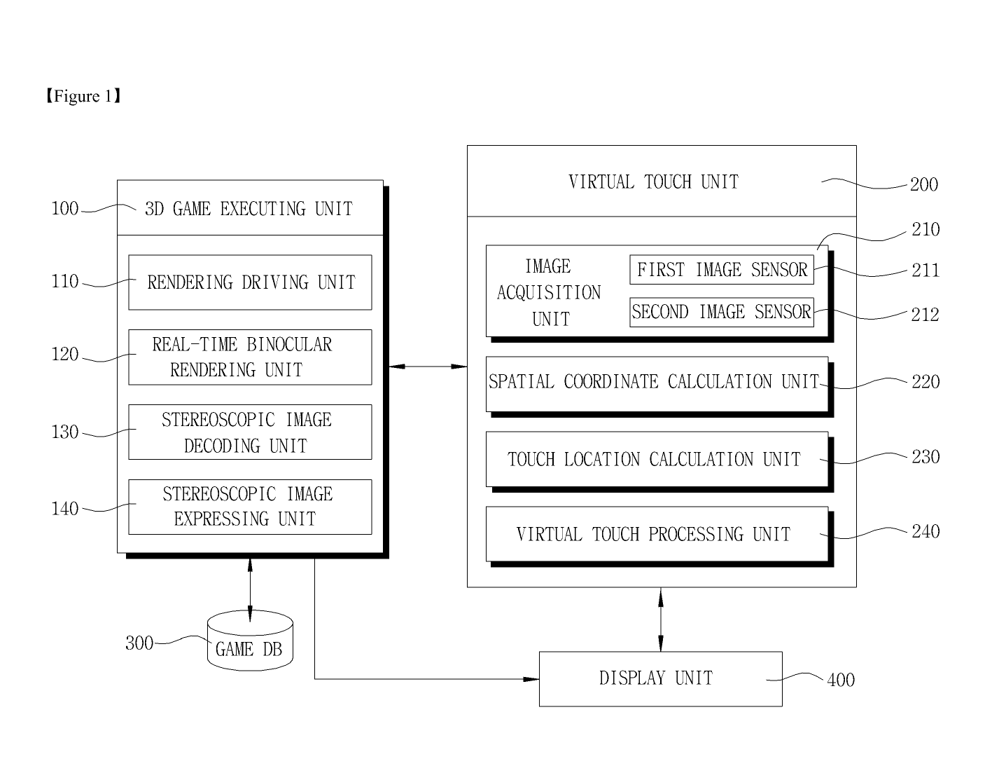

FIG. 1 is a view illustrating a 3D game device using a virtual touch according to a first embodiment of the present invention.

Referring to FIG. 1, the 3D game device may include a 3D game executing unit 100 and a virtual touch unit 200. The 3D game executing unit 100 may render a 3D stereoscopic game pre-stored in a game DB 300, and may generate a 3D stereoscopic image regarding the rendered 3D stereoscopic game to provide the 3D stereoscopic image to a display unit 400. The virtual touch unit 200 may generate 3D spatial coordinate data (hereinafter, referred to as “spatial coordinate data”) of specific points (tip of hand, pen, fist, palm, face, and mouth) of a user and 3D image coordinate data (hereinafter, referred to as “image coordinate data”) from a point of user's view (hereinafter, referred to as “user's viewpoint”) regarding the 3D stereoscopic image provided from the display unit 400, and may compare the generated spatial coordinate data and image coordinate data to verify whether or not the specific points of a user contact or approach the 3D stereoscopic image and thus recognize a touch of the 3D stereoscopic image.

In this case, the 3D game executing unit 100 may include a rendering driving unit 110, a real-time binocular rendering unit 120, a stereoscopic image decoding unit 130, and a stereoscopic image expressing unit 140.

The rendering driving unit 110 may render and execute a 3D game stored in the game DB 300.

The real-time binocular rendering unit 120 may generate images corresponding to both eyes by performing rendering in real-time in consideration of a distance and a location (view angle) between the display unit 400 and a user to generate a 3D screen on the display unit 400 regarding the 3D game that is rendered.

The stereoscopic image decoding unit 130 may compress and restore the images generated in the real-time binocular rendering unit 120 to provide the images to the stereoscopic image expressing unit 140.

The stereoscopic image expressing unit 140 may convert the image data compressed and restored in the stereoscopic image decoding unit 130 into a 3D stereoscopic image suitable for the display method of the display unit 400 to display the 3D stereoscopic image through the display unit 400. In this case, the display method of the display unit 400 may be a parallax barrier method. The parallax barrier method is to observe a separation of an image through an aperture AG of a vertical lattice shape in front of L and R images corresponding to the left and right eyes.

Also, the virtual touch unit 200 may include an image acquisition unit 210, a spatial coordinate calculation unit 220, a touch location calculation unit 230, and a virtual touch calculation unit 240.

The image acquisition unit 210, which is a sort of camera module, may include two or more image sensors 211 and 212 such as CCD or CMOS, which detect an image in front of the display unit 400 to convert the image into an electrical image signal.

The spatial coordinate calculation unit 220 may generate image coordinate data according to the 3D stereoscopic image from the user's viewpoint and first and second spatial coordinate data of specific points (tip of hand, pen, fist, palm, face, and mouth) of a user, using the image received from the image acquisition unit 210.

Regarding the spatial coordinates of specific points of a user, the image acquisition unit 210 may photograph the specific points of a user from different angles through the image sensors 211 and 212 of the image acquisition unit 210, and the spatial coordinate calculation unit 220 may calculate the spatial coordinate data of the specific points of a user by passive optical triangulation. The spatial coordinate data that are calculated may include the first spatial coordinate data for detecting a motion of a user for touching the 3D stereoscopic image, and the second spatial coordinate data that become reference points between the stereoscopic image and the first spatial coordinate data according to the motion.

Also, the spatial coordinate data of the left and right eyes of a user may be calculated from the image coordinate data of the 3D stereoscopic image by the passive optical triangulation for the left and right eyes of a user photographed from different angles. Thus, the distance and position (view angle) between the display unit 400 and the user may be calculated. Also, the image coordinate data of the user's viewpoint pre-stored according to the distance and position between the display unit 400 and the user may be retrieved and detected.

Thus, when only the spatial coordinate data are generated using the images received through the image acquisition unit 210, the image coordinate of the user's viewpoint can be easily detected. For this, the image coordinate data of the user's viewpoint according to the distance and position between the display unit 400 and the user need to be predefined.

Hereinafter, a method of calculating the spatial coordinates will be described in more detail.

Generally, the optical spatial coordinate calculation method may be classified into an active type and a passive type according to the sensing method. The active type may typically use structured light or laser light, which calculates the spatial coordinate data of an object by projecting a predefined pattern or a sound wave to the object and then measuring a variation through control of sensor parameters such as energy or focus. On the other hand, the passive type may use the intensity and parallax of an image photographed when energy is not artificially projected to an object.

In this embodiment, the passive type that does not project energy to an object is adopted. The passive type may be reduced in precision compared to the active type, but may be simple in equipment and can directly acquire a texture from an input image.

In the passive type, 3D information can be acquired by applying the triangulation regarding features corresponding to photographed images. Examples of related techniques that extract the spatial coordinates using the triangulation may include a camera self calibration method, a Harris corner extracting method, SIFT method, and RANSAC method, and Tsai method. Particularly, a stereoscopic camera technique may be used as a method of calculating the 3D spatial coordinate data of a user's body. The stereoscopic camera technique is a method of acquiring a distance from an expected angle with respect to a point by observing the same point of the surface of an object from two different points, similarly to a structure of binocular stereoscopic view that obtains a variation of an object from two eyes of human. The above-mentioned 3D coordinate calculation techniques can be easily carried out by those skilled in the art, a detailed description thereof will be omitted herein. Meanwhile, regarding the method of calculating 3D coordinate data using a 2D image, there are many patent-related documents, for example, Korean Patent Application Publication Nos. 10-0021803, 10-2004-0004135, 10-2007-0066382, and 10-2007-0117877.

The touch location calculation unit 230 may calculate contact point coordinate data where a straight line connecting the first and second spatial coordinates of a specific point of a user, received from the spatial coordinate calculation unit 220, meets the image coordinate. In case of 3D game, the specific points of a user, used as motion, may be usually different from each other according to the types of game. For example, boxing and fighting games may use the fist and the foot as specific points used as motions, and a heading game may use the head as a specific point used as motion. Accordingly, specific points used as the first spatial coordinates may be differently set according to the types of 3D games that are executed.

In a similar context, a pointer (e.g., bat) gripped by fingers may be used instead of a specific point of a user serving as the first spatial coordinate. When such a pointer is used, the pointer may be applied to various 3D games.

Also, in this embodiment, the central point of only one eye of a user may be used to calculate the second spatial coordinate corresponding to the reference point. For example, when a user views his/her finger at the front of his/her eyes, the finger may appear two. This occurs because the shapes of the finger viewed by both eyes are different from each other (i.e., due to an angle difference between both eyes). However, when the finger is viewed by only one eye, the finger may be clearly seen. Also, although a user does not close one of eyes, when he views the finger using only one eye consciously, the finger can be clearly seen. Aiming at a target with only one eye in archery and shooting that require a high degree of accuracy complies with the above-mentioned principle.

In this embodiment, the principle that the shape of the tip of finger can be clearly recognized when the first spatial coordinate is viewed by only one eye may be applied. Thus, when a user can exactly select the first spatial coordinate, the 3D stereoscopic image of 3D coordinate matching the first spatial coordinate can be touched.

In this embodiment, when one user uses one hand as a specific point used as motion, the first spatial coordinate may become the coordinate of the tip of the user's hand or the tip of a pointer gripped by the hand of the user, and the second spatial coordinate may become the coordinate of the central point of one of user's eyes.

Also, when one user uses two or more (two hands or two feet) of specific points used as motion, the first spatial coordinate may be the coordinates of the tips of two or more hands or feet among the user specific points, and the second spatial coordinate may be the coordinates of the central point of one of user's eyes.

When there are two or more users, the first spatial coordinate may be the coordinates of the tips of one or more specific points provided by two or more users, respectively, and the second spatial coordinate may be the coordinates of the central points of one of eyes of the two or more users.

The virtual touch processing unit 240 may determine whether or not the first spatial coordinate generated in the spatial coordinate calculation unit 220 contacts or approaches the contact point coordinate data calculated by the touch location calculation unit 230. When the first spatial coordinate received from the spatial coordinate calculation unit 220 contacts or gets close to the contact point coordinate data within a predetermined distance, the virtual touch processing unit 240 may generate a command code of performing a touch recognition to provide the touch recognition of the 3D stereoscopic image. The virtual touch processing unit 522 may similarly operate regarding two specific points of one user or regarding two or more users.

The virtual touch apparatus 200 according to the embodiment of the present invention may be installed in the upper end of the frame of electronic equipment including the display unit 400, or may be installed separately from electronic equipment.

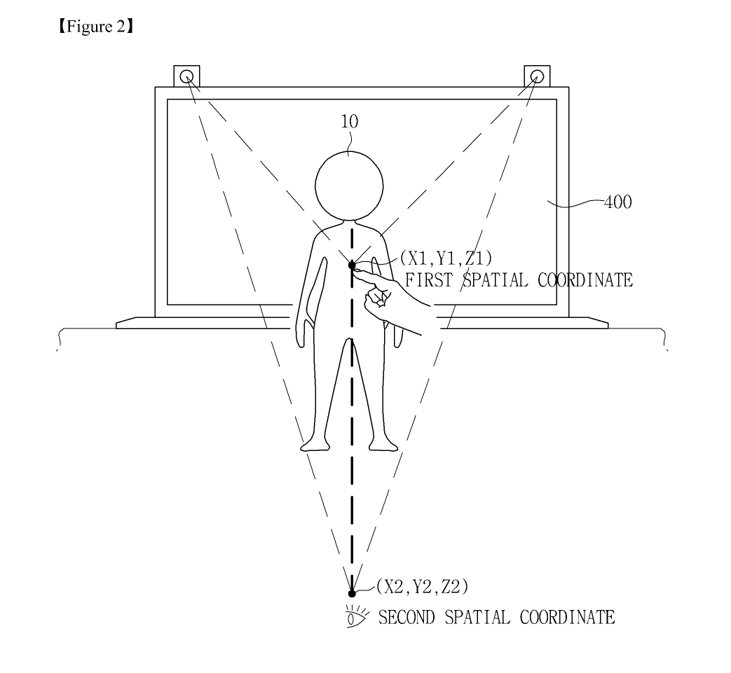

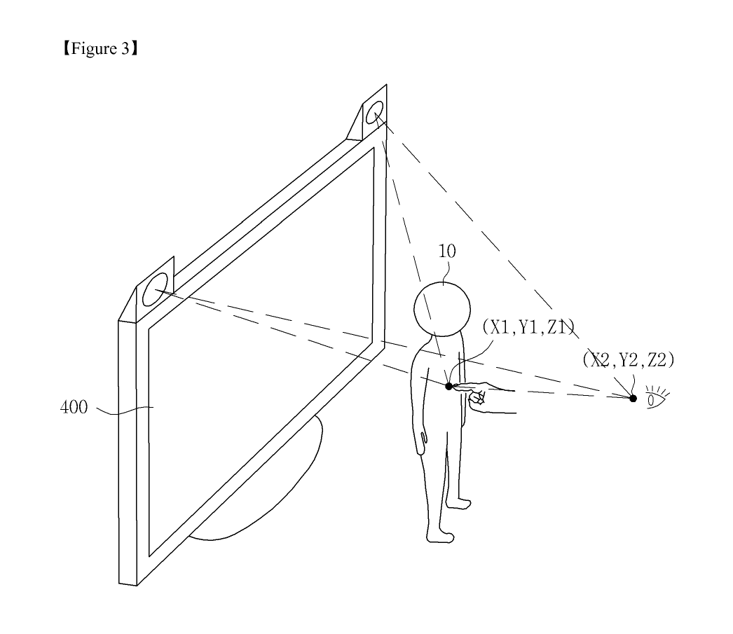

FIGS. 2 and 3 are views illustrating a method of recognizing a touch of a 3D stereoscopic image viewed by a user in a 3D game using a virtual touch according to an embodiment of the present invention.

As shown in the drawing, when the 3D game is executed through the 3D game executing unit 100 and thus the 3D stereoscopic image according to the 3D game is generated, a user may touch the 3D stereoscopic image while viewing a specific point of a user with one eye.

In this case, the spatial coordinate calculation unit 220 may generate a 3D spatial coordinate of a specific point of a user, and the touch location calculation unit 230 may calculate a contact point coordinate data where a straight line connecting the first spatial coordinate data (X1, Y1, Z1) of the specific point and the second spatial coordinate data (X2, Y2, Z2) of the central point of one eye meets the stereoscopic coordinate data.

Thereafter, the virtual touch processing unit 240 may recognize that a user has touched the 3D stereoscopic image when it is determined that the first spatial coordinate generated in the spatial coordinate calculation unit 220 contacts or approaches the contact point coordinate data calculated by the touch location calculation unit 230.

### Embodiment 2

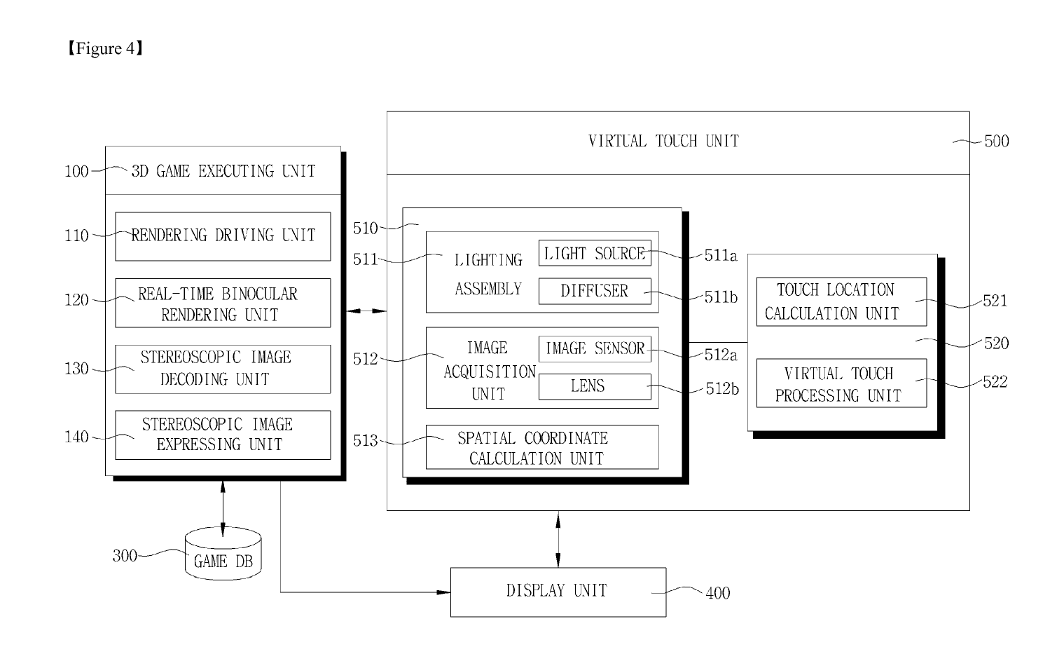

FIG. 4 is a view illustrating a 3D game device using a virtual touch according to a second embodiment of the present invention.

Referring to FIG. 4, the 3D game device using virtual touch may include a 3D game executing unit 100 and a virtual touch unit 500. The 3D game executing unit 100 may render a 3D stereoscopic game pre-stored in a game DB 300, and may generate a 3D stereoscopic image regarding the rendered 3D stereoscopic game to provide the 3D stereoscopic image to a display unit 400. The virtual touch unit 500 may generate 3D spatial coordinate data (hereinafter, referred to as “spatial coordinate data”) of specific points (tip of hand, pen, fist, palm, face, and mouth) of a user and 3D image coordinate data (hereinafter, referred to as “image coordinate data”) from a point of user's view (hereinafter, referred to as “user's viewpoint”) regarding the 3D stereoscopic image provided from the display unit 400, and may compare the generated spatial coordinate data and image coordinate data to verify whether or not the specific points of a user contact or approach the 3D stereoscopic image and thus recognize a touch of the 3D stereoscopic image.

In this case, the 3D game executing unit 100 may include a rendering driving unit 110, a real-time binocular rendering unit 120, a stereoscopic image decoding unit 130, and a stereoscopic image expressing unit 140. Since each component has already described in the first embodiment, a detailed description thereof will be omitted herein.

Also, the virtual touch unit 500 may include a three-dimensional coordinate calculator 510 extracting three-dimensional coordinate data of a user's body and a controller 520.

The three-dimensional coordinate calculator 510 may calculate the spatial coordinates of a specific point of the user's body using various three-dimensional coordinate extraction methods that are known. Examples of spatial coordinate extraction methods may include optical triangulations and time delay measurements. A three-dimensional information acquisition technique, which is an active method using structured light as one of the optical triangulations, may estimate a three-dimensional location by continuously projecting coded pattern images using a projector and obtaining images on which the structured light is projected using a camera.

Also, the time delay measurement may be a technique that obtains three-dimensional information using a distance converted by dividing the time of flight taken for an ultrasonic wave from a transmitter to be reflected by an object and reach a receiver by a traveling speed of the ultrasonic wave. In addition, since there are various three-dimensional coordinate calculation methods using the time of flight, which can be easily carried out by those skilled in the art, a detailed description thereof will be omitted herein.

Also, the three-dimensional coordinate calculator 510 may include a lighting assembly 511, an image acquisition unit 512, and a spatial coordinate calculation unit 513. The lighting assembly 512 may include a light source 511a and a light diffuser 511b, and may project a speckle pattern on a user's body. The image acquisition unit 512 may include an image sensor 512a and a lens 512b to capture the speckle pattern on the user's body projected by the lighting assembly 511. The image sensor 512a may usually include a CCD or CMOS image sensor. Also, the spatial coordinate calculation unit 513 may serve to calculate three-dimensional data of the user's body by processing the images acquired by the image acquisition unit 512.

The controller 520 may include a touch location calculation unit 521 and a virtual touch calculation unit 522.

In this case, the touch location calculation unit 521 may serve to calculate contact point coordinates where a straight line connecting between a first spatial coordinate and a second spatial coordinate that are received from the three-dimensional coordinate calculation unit 510 meets the image coordinate data. In case of 3D game, the specific points of a user, used as motion, may be usually different from each other according to the types of game. For example, boxing and fighting games may use the fist and the foot as specific points used as motions, and a heading game may use the head as a specific point used as motion. Accordingly, specific points used as the first spatial coordinates may be differently set according to the types of 3D games that are executed.

In a similar context, a pointer (e.g., bat) gripped by fingers may be used instead of a specific point of a user serving as the first spatial coordinate. When such a pointer is used, the pointer may be applied to various 3D games.

Also, in this embodiment, the central point of only one eye of a user may be used to calculate the second spatial coordinate corresponding to the reference point. For example, when a user views his/her finger at the front of his/her eyes, the finger may appear two. This occurs because the shapes of the finger viewed by both eyes are different from each other (i.e., due to an angle difference between both eyes). However, when the finger is viewed by only one eye, the finger may be clearly seen. Also, although a user does not close one of eyes, when he views the finger using only one eye consciously, the finger can be clearly seen. Aiming at a target with only one eye in archery and shooting that require a high degree of accuracy complies with the above-mentioned principle.

In this embodiment, the principle that the shape of the tip of finger can be clearly recognized when the first spatial coordinate is viewed by only one eye may be applied. Thus, when a user can exactly select the first spatial coordinate, the 3D stereoscopic image of 3D coordinate matching the first spatial coordinate can be touched.

In this embodiment, when one user uses one hand as a specific point used as motion, the first spatial coordinate may become the coordinate of the tip of the user's hand or the tip of a pointer gripped by the hand of the user, and the second spatial coordinate may become the coordinate of the central point of one of user's eyes.

Also, when one user uses two or more (two hands or two feet) of specific points used as motion, the first spatial coordinate may be the coordinates of the tips of two or more hands or feet among the user specific points, and the second spatial coordinate may be the coordinates of the central point of one of user's eyes.

When there are two or more users, the first spatial coordinate may be the coordinates of the tips of one or more specific points provided by two or more users, respectively, and the second spatial coordinate may be the coordinates of the central points of one of eyes of the two or more users.

The virtual touch processing unit 522 may determine whether or not the first spatial coordinate received from the 3D coordinate calculator 510 contacts or approaches the contact point coordinate data calculated by the touch location calculation unit 521. When the first spatial coordinate received from the 3D coordinate calculator 510 contacts or gets close to the contact point coordinate data within a predetermined distance, the virtual touch processing unit 522 may generate a command code of performing a touch recognition to provide the touch recognition of the 3D stereoscopic image. The virtual touch processing unit 522 may similarly operate regarding two specific points of one user or regarding two or more users.

The virtual touch apparatus 500 according to the embodiment of the present invention may be installed in the upper end of the frame of electronic equipment including the display unit 400, or may be installed separately from electronic equipment.

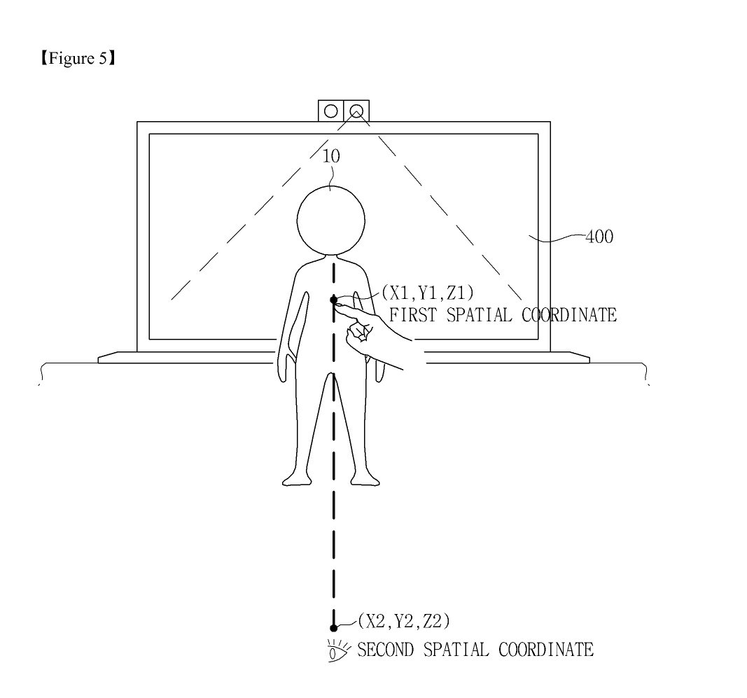

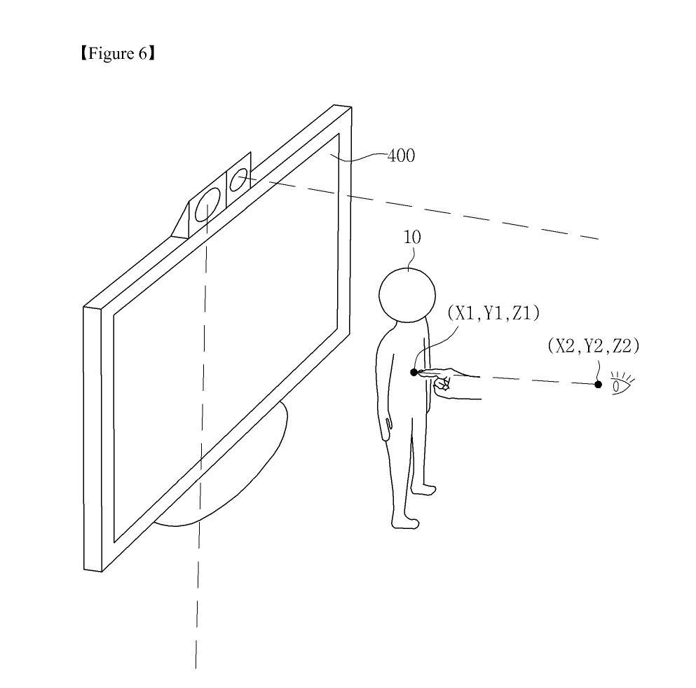

FIGS. 5 and 6 are views illustrating a method of recognizing a touch of a 3D stereoscopic image viewed by a user in a 3D game using a virtual touch according to an embodiment of the present invention.

As shown in the drawing, when the 3D game is executed through the 3D game executing unit 100 and thus the 3D stereoscopic image according to the 3D game is generated, a user may touch the 3D stereoscopic image while viewing a specific point of a user with one eye.

In this case, the spatial coordinate calculation unit 513 may generate a 3D spatial coordinate of a specific point of a user, and the touch location calculation unit 521 may calculate a contact point coordinate data where a straight line connecting the first spatial coordinate data (X1, Y1, Z1) of the specific point and the second spatial coordinate data (X2, Y2, Z2) of the central point of one eye meets the stereoscopic coordinate data.

Thereafter, the virtual touch processing unit 522 may recognize that a user has touched the 3D stereoscopic image when it is determined that the first spatial coordinate generated in the spatial coordinate calculation unit 513 contacts or approaches the contact point coordinate data calculated by the touch location calculation unit 521.

### Embodiment 3

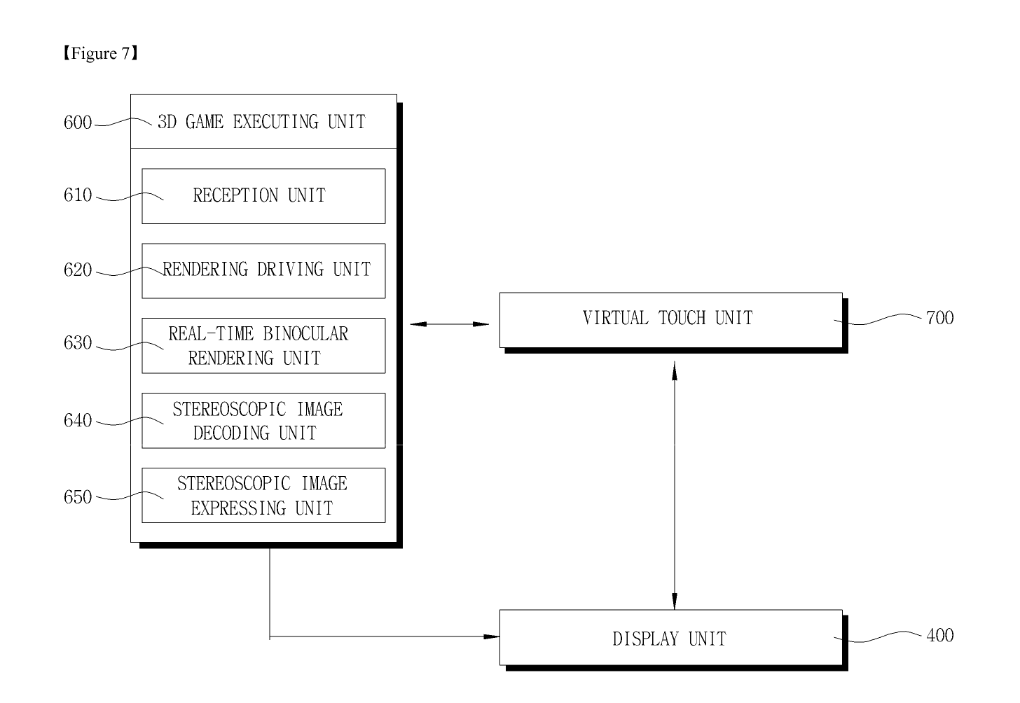

FIG. 7 is a view illustrating a 3D device using a virtual touch according to a third embodiment of the present invention.

Referring to FIG. 7, the 3D device using virtual touch may include a 3D executing unit 600 and a virtual touch unit 700. The 3D game executing unit 600 may render a 3D stereoscopic image data inputted from the outside, and may generate a 3D stereoscopic image regarding the rendered 3D stereoscopic image data to provide the 3D stereoscopic image to a display unit 400. The virtual touch unit 700 may generate 3D spatial coordinate data (hereinafter, referred to as “spatial coordinate data”) of specific points (tip of hand, pen, fist, palm, face, and mouth) of a user and 3D image coordinate data (hereinafter, referred to as “image coordinate data”) from a point of user's view (hereinafter, referred to as “user's viewpoint”) regarding the 3D stereoscopic image provided from the display unit 400, and may compare the generated spatial coordinate data and image coordinate data to verify whether or not the specific points of a user contact or approach the 3D stereoscopic image and thus recognize a touch of the 3D stereoscopic image.

In this case, the 3D executing unit 600 may include a reception unit 610, a rendering driving unit 620, a real-time binocular rendering unit 640, a stereoscopic image decoding unit 640, and a stereoscopic image expressing unit 650.

The reception unit 610 may receive the 3D stereoscopic image data inputted from the outside. In this case, the external input, like recent public TV, may be an input of 3D broadcast provided through the broadcast wave, or may be 3D data provided through Internet network. Alternatively, 3D stereoscopic image data stored in internal/external storages may be inputted.

The rendering driving unit 620 may render and execute the 3D stereoscopic image data received by the reception unit 610.

The real-time binocular rendering unit 630 may generate images corresponding to both eyes by performing rendering in real-time in consideration of a distance and a location (view angle) between the display unit 400 and a user to generate a 3D screen on the display unit 400 regarding the 3D stereoscopic image data that are rendered.

The stereoscopic image decoding unit 640 may compress and restore the images generated in the real-time binocular rendering unit 630 to provide the images to the stereoscopic image expressing unit 650.

The stereoscopic image expressing unit 650 may convert the image data compressed and restored in the stereoscopic image decoding unit 640 into a 3D stereoscopic image suitable for the display method of the display unit 400 to display the 3D stereoscopic image through the display unit 400.

Also, the virtual touch unit 700 may be configured with one of the components described in the first and second embodiments.

In other words, the virtual touch unit 700 may include the image acquisition unit 210, the spatial coordinate calculation unit 220, the touch location calculation unit 230, and the virtual touch calculation unit 240, which are described in the first embodiment, and may calculate spatial coordinate data of specific points of a user using optical triangulation of photographed images. The virtual touch unit 700 may include the 3D coordinate calculator 510 that extracts 3D coordinate data of a user's body and the controller 520, which are described in the second embodiment, and may calculate spatial coordinate data of specific point of a user using time of flight of photographed images.

Since the virtual touch unit 700 is described in detail in the first and second embodiments, a detailed description thereof will be omitted herein.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

### INDUSTRIAL APPLICABILITY

The present invention has industrial applicability since it can allow a user to more precisely manipulate a virtual 3D stereoscopic image and thus, provide a more realistic and vivid 3D game.

1. A three-dimensional game device using a virtual touch, including:
a 3D game executing unit rendering a 3D stereoscopic game pre-stored in a game database and generating a 3D stereoscopic image regarding the rendered 3D game to provide the 3D stereoscopic image to a display unit; and
a virtual touch unit generating spatial coordinate data of a specific point of a user and image coordinate data from a user's viewpoint using the 3D stereoscopic image provided from the display unit and comparing the generated spatial coordinate data and image coordinate data to verify whether or not a specific point of a user contacts or approaches the 3D stereoscopic image and thus recognize a touch of the 3D stereoscopic image.

2. The three-dimensional game device of claim 1, wherein the specific point comprises a tip of hand, a fist, a palm, a face, a mouth, a head, a foot, a hip, a shoulder, and a knee.

3. The three-dimensional game device of claim 1, wherein the 3D game executing unit includes:
a rendering driving unit rendering and executing the 3D game stored in the game database;
a real-time binocular rendering unit generating images corresponding to both eyes by performing rendering in real-time in consideration of a distance and a location (view angle) between the display unit and a user to generate a 3D screen on the display unit regarding the 3D game that is rendered;
a stereoscopic image decoding unit compressing and restoring the images generated in the real-time binocular rendering unit; and
a stereoscopic image expressing unit converting the image data compressed and restored in the stereoscopic image decoding unit into a 3D stereoscopic image suitable for the display method of the display unit to display the 3D stereoscopic image through the display unit.

4. The three-dimensional game device of claim 1, wherein the virtual touch unit includes:
an image acquisition unit comprising two or more image sensors and detecting an image in front of the display unit to convert the image into an electric image signal;
a spatial coordinate calculation unit generating image coordinate data according to the 3D stereoscopic image of a user's viewpoint from the image acquired by the image acquisition unit and first and second spatial coordinate data of a specific point of a user;
a touch location calculation unit for calculating contact point coordinate data where a straight line connecting the first and second spatial coordinates of a specific point of a user received from the spatial coordinate calculation unit meets the image coordinate; and
a virtual touch calculation unit determining whether or not the first spatial coordinate generated in the spatial coordinate calculation unit contacts or approaches the contact point coordinate data calculated in the touch location calculation unit to generate a command code for performing touch recognition of the 3D stereoscopic image when the first spatial coordinate contacts or approaches the contact point coordinate data within a predetermined distance.

5. The three-dimensional game device of claim 4, wherein the spatial coordinate calculation unit calculates the spatial coordinate data of a specific point of a user from photographed images using optical triangulation.

6. The three-dimensional game device of claim 5, wherein the calculated spatial coordinate data comprise the first spatial coordinate data for detecting a motion of a user for touching the 3D stereoscopic image and the second spatial coordinate data that is a reference point between the 3D stereoscopic image and the first spatial coordinate according to the motion.

7. The three-dimensional game device of claim 4, wherein the spatial coordinate calculation unit retrieves and detects the image coordinate data of a user's viewpoint pre-defined and stored according to a distance and a location between the display unit and a user.

8. The three-dimensional game device of claim 4, wherein the second spatial coordinate is a coordinate of a central point of one of user's eyes.

9. The three-dimensional game device of claim 1, wherein the virtual touch unit includes:
a lighting assembly comprising a light source and a diffuser and projecting a speckle pattern on a specific point of a user;
an image acquisition unit comprising an image sensor and a lens and capturing the speckle pattern of a user projected on the lighting assembly;
a spatial coordinate calculation unit generating image coordinate data according to the 3D stereoscopic image of a user's viewpoint from the image acquired by the image acquisition unit and first and second spatial coordinate data of a specific point of a user;
a touch location calculation unit for calculating contact point coordinate data where a straight line connecting the first and second spatial coordinates of a specific point of a user received from the spatial coordinate calculation unit meets the image coordinate; and
a virtual touch calculation unit determining whether or not the first spatial coordinate generated in the spatial coordinate calculation unit contacts or approaches the contact point coordinate data calculated in the touch location calculation unit to generate a command code for performing touch recognition of the 3D stereoscopic image when the first spatial coordinate contacts or approaches the contact point coordinate data within a predetermined distance.

10. The three-dimensional game device of claim 1, wherein the spatial coordinate calculation unit calculates the spatial coordinate data of a specific point of a user by time of flight.

11. The three-dimensional game device of claim 9, wherein the calculated spatial coordinate data comprise the first spatial coordinate data for detecting a motion of a user for touching the 3D stereoscopic image and the second spatial coordinate data that is a reference point between the 3D stereoscopic image and the first spatial coordinate according to the motion.

12. The three-dimensional game device of claim 9, wherein the spatial coordinate calculation unit retrieves and detects the image coordinate data of a user's viewpoint pre-defined and stored according to a distance and a location between the display unit and a user.

13. The three-dimensional game device of claim 9, wherein the image acquisition unit comprises an image sensor comprising Charge-Coupled Device (CCD) or Complementary Metal-Oxide-Semiconductor (CMOS).

14. The three-dimensional game device of claim 1, wherein the virtual touch unit is installed in an upper end of a frame of electronic equipment comprising the display unit, or may be installed separately from electronic equipment

15. A three-dimensional device using a virtual touch, including:
a 3D executing unit rendering 3D stereoscopic image data inputted from the outside and generating a 3D stereoscopic image regarding the rendered 3D stereoscopic image data to provide the 3D stereoscopic image to a display unit; and
a virtual touch unit generating 3D spatial coordinate data of specific points of a user and 3D image coordinate data from a point of user's view regarding the 3D stereoscopic image provided from the display unit and comparing the generated spatial coordinate data and image coordinate data to verify whether or not the specific points of a user contact or approach the 3D stereoscopic image and thus recognize a touch of the 3D stereoscopic image.

16. The three-dimensional device of claim 15, wherein the 3D executing unit includes:
a reception unit receiving the 3D stereoscopic image data inputted from the outside;
a rendering driving unit rendering and executing the 3D stereoscopic image data received by the reception unit;
a real-time binocular rendering unit generating images corresponding to both eyes by performing rendering in real-time in consideration of a distance and a location (view angle) between the display unit and a user to generate a 3D screen on the display unit regarding the 3D stereoscopic image data that are rendered;
a stereoscopic image decoding unit compressing and restoring the images generated in the real-time binocular rendering unit; and
a stereoscopic image expressing unit converting the image data compressed and restored in the stereoscopic image decoding unit into a 3D stereoscopic image suitable for the display method of the display unit to display the 3D stereoscopic image through the display unit.

17. The three-dimensional device of claim 16, wherein the external input of the reception unit comprises an input of 3D broadcast provided through a broadcast wave, an input of 3D data provided through an Internet network, and an input of data stored in internal/external storages.

18. The three-dimensional device of claim 16, wherein the virtual touch unit calculates spatial coordinate data of specific points of a user using optical triangulation of photographed images

19. The three-dimensional device of claim 18, wherein the virtual touch unit includes components described in claim 4.

20. The three-dimensional device of claim 16, wherein the virtual touch unit calculates spatial coordinate data of specific points of a user using time of flight of photographed images.

21. The three-dimensional device of claim 20, wherein the virtual touch unit includes components described in claim 9.
